(19) United States
(12) Patent Application Publication
(10) Pub. No.: US 2020/0018236 A1
(43) Pub. Date: Jan. 16, 2020

(54) COOLING STRUCTURE FOR TURBINE AIRFOIL

(71) Applicant: KAWASAKI JUKOGYO KABUSHIKI KAISHA, Kobe-shi (JP)

(72) Inventors: Tomoko TSURU, Akashi-shi (JP); Katsuhiko ISHIDA, Kobe-shi (JP)

(73) Assignee: KAWASAKI JUKOGYO KABUSHIKI KAISHA, Kobe-shi (JP)

(21) Appl. No.: 16/558,677

(22) Filed: Sep. 3, 2019

Related U.S. Application Data
(63) Continuation of application No. PCT/JP2018/008644, filed on Mar. 6, 2018.

(30) Foreign Application Priority Data
Mar. 10, 2017 (JP) 2017-045926

(51) Int. Cl. F02C 7/18; F01D 5/18; F01D 25/12

(52) U.S. Cl. CPC F02C 7/18; F01D 25/12; F01D 5/18

(57) ABSTRACT

A structure for cooling a turbine airfoil includes: a cooling passage formed between a first airfoil wall curved so as to be concave, and a second airfoil wall curved so as to be convex, relative to a high-temperature gas passage; and a lattice structure body formed by stacking, in a lattice pattern, a plurality of main ribs provided on both wall surfaces facing the cooling passage. The lattice structure body includes a supplemental rib integrally provided to the main ribs so as to protrude in a lattice passage formed between the adjacent main ribs, and the supplemental rib provided on an inner wall surface of the first airfoil wall and the supplemental rib provided on an inner wall surface of the second airfoil wall are provided at positions that do not overlap each other.

### CROSS REFERENCE TO THE RELATED APPLICATION

This application is a continuation application, under 35 U.S.C. § 111(a), of international application No. PCT/JP2018/008644, filed Mar. 6, 2018, which claims priority to Japanese patent application No. 2017-045926, filed Mar. 10, 2017, the disclosure of which are incorporated by reference in their entirety into this application.

### BACKGROUND OF THE INVENTION

### Field of the Invention

The present invention relates to a structure for internally cooling a turbine airfoil of a gas turbine engine, that is, a stator vane and a rotor blade in a turbine.

### Description of Related Art

A turbine that forms a part of a gas turbine engine is disposed downstream of a combustor and high-temperature gas burnt in the combustor is supplied to the turbine. Thus, the turbine is exposed to high temperatures during operation of the gas turbine engine. Therefore, it is necessary to cool a turbine airfoil, that is, a stator vane and a rotor blade. As a structure for cooling such a turbine airfoil, it has been known to introduce part of an air compressed by a compressor into a cooling passage formed in the airfoil and cool the turbine airfoil using the compressed air as a cooling medium (see, for example, Patent Document 1).

In the case of using part of the compressed air to cool the turbine airfoil, it is not necessary to introduce a cooling medium from the outside, so that there is a merit that the cooling structure can be simplified. However, when a large amount of air compressed by the compressor is used for cooling, it leads to a reduction in engine efficiency. Thus, it is necessary to efficiently perform cooling with as little air as possible. As a structure for cooling a turbine airfoil with high efficiency, use of a so-called lattice structure body formed by combining a plurality of ribs in a lattice pattern has been proposed (see, for example, Patent Document 2). Generally, in the lattice structure body, opposite side ends thereof are closed by end portion wall surfaces. Meanwhile, the cooling medium flowing through one passage comes into contact with a partition plate, which is a wall surface partitioning the inside and the outside of the structure, is deflected and flows into the other passage. Similarly, the cooling medium flowing through the other passage comes into contact with the partition plate of the structure, is deflected and flows into the one passage. By the cooling medium repeating the contact with the end portion wall surface and the deflection as described above, cooling is enhanced. In addition, cooling is enhanced by vortex flow generated when the cooling medium traverses the ribs of the lattice pattern.

### RELATED DOCUMENT

### Patent Document

[Patent Document 1] U.S. Pat. No. 5,603,606

[Patent Document 2] JP Patent No. 4957131

### SUMMARY OF THE INVENTION

The lattice structure body of Patent Document 2 is divided by a plurality of partition plates that extend along a movement direction of the cooling medium. The cooling medium is deflected at the partition plates as well as at the end portion wall surfaces. That is, cooling is enhanced by increasing the frequency in which the cooling medium comes into contact with the wall surface. However, in the case where a large number of partition plates are provided to the lattice structure body and the number of passages between the partition plates is decreased, when a part of the passages is clogged for some reason, the flow rate balance in all the passages between the partition plates is largely biased. As a result, a cooling distribution in the airfoil is biased, thereby reducing the durability of the turbine airfoil.

Therefore, in order to solve the above-described problem, an object of the present invention is to provide a cooling structure that is able to cool a turbine airfoil with high efficiency while suppressing durability reduction of the turbine airfoil.

In order to achieve the above-described object, a cooling structure for a turbine airfoil according to a first aspect of the present invention is a structure for cooling a turbine airfoil of a turbine driven by high-temperature gas, the structure including:

a cooling passage formed between a first airfoil wall and a second airfoil wall of the turbine airfoil that oppose each other; and

a lattice structure body including
a first rib set including a plurality of first main ribs, provided on a first inner wall surface of the first airfoil wall facing the cooling passage, that extend linearly and arranged so as to be parallel to each other, and
a second rib set including a plurality of second main ribs, provided on a second inner wall surface of the second airfoil wall facing the cooling passage, that extend linearly and are arranged so as to be parallel to each other, the second rib set being stacked on the first rib set so as to form a lattice pattern,

in which the first rib set includes a first supplemental rib that is provided on the first inner wall surface and integrally provided to the first main rib so as to protrude in a lattice passage formed between the adjacent first main ribs, and

the second rib set includes a second supplemental rib that is provided on the second inner wall surface and integrally provided to the second main rib so as to protrude in a lattice passage formed between the adjacent second main ribs, the second supplemental rib being disposed at a position that do not overlap the first supplemental rib in a direction in which the first inner wall surface and the second inner wall surface oppose each other.

According to this configuration, by a cooling medium passing through the lattice communication portion and traversing the other rib set extending in a direction traversing the lattice passage, vortex flow is generated in flow of the cooling medium, and cooling of the wall surface is enhanced. In addition, by the cooling medium colliding against the supplemental rib that protrudes in the lattice passage, the cooling medium is deflected to another lattice passage, so that the same cooling effect as that in the case where a partition plate that is a continuously provided structure is provided to the lattice structure body can be obtained without providing such a partition plate. Furthermore, unlike a continuous partition plate, it is easy to selectively arrange the supplemental ribs such that the cooling efficiency by the lattice structure body is optimized in accordance with the thermal load distribution within the turbine airfoil. Therefore, high cooling efficiency can be achieved while durability reduction of the turbine airfoil is suppressed.

In one embodiment of the present invention, a movement direction of an entirety of the cooling medium may be a direction from a base portion toward a tip portion in a height direction of the turbine airfoil, and a greater number of the first supplemental rib and a greater number of the second supplemental rib may be arranged in a region on the base portion side of the turbine airfoil in the lattice structure body. In this case, for example, the first supplemental ribs and the second supplemental ribs may be arranged only in a half region on the base portion side of the turbine airfoil in the lattice structure body. According to this configuration, since the supplemental ribs are arranged mainly in the base portion of the turbine airfoil which is a portion to which great stress is applied and thus is a portion for which the necessity for cooling is higher, higher cooling efficiency is achieved.

In one embodiment of the present invention, at least one of the first airfoil wall and the second airfoil wall may be formed with a film cooling hole that penetrates from the inner wall surface of the airfoil wall on which the lattice structure body is provided, to an outer wall surface of the airfoil wall. According to this configuration, the entirety of the turbine airfoil can be efficiently cooled by using vortex flow of the cooling medium that has occurred in the lattice structure body having the supplemental ribs, also for film cooling of the turbine airfoil outer wall surface.

In one embodiment of the present invention, the lattice structure body may include a plurality of lattice communication portions that allow lattice passages formed between the plurality of the first main ribs to communicate with lattice passages formed between the plurality of the second main ribs, and the film cooling hole may be formed in the second airfoil wall and may penetrate to an outer wall surface of the second airfoil wall from a portion of the second inner wall surface, that is on a downstream side with respect to a position, in the lattice passage between the second main ribs, corresponding to the first supplemental rib, such that at least one lattice communication portion is present between the portion of the second inner wall surface and a lattice communication portion at the position corresponding to the first supplemental rib. According to this configuration, the cooling medium in which vortex flow having sufficient intensity has occurred by traversing the ribs after deflection due to the supplemental rib can be used for film cooling of the turbine airfoil outer wall surface, and thus it is possible to further efficiently cool the entirety of the turbine airfoil.

A cooling structure for a turbine airfoil according to a second aspect of the present invention is a structure for cooling a turbine airfoil of a turbine driven by high-temperature gas, the structure including:

a cooling passage formed between a first airfoil wall and a second airfoil wall of the turbine airfoil that oppose each other; and

a lattice structure body including a first rib set including a plurality of ribs provided on an inner wall surface of the first airfoil wall facing the cooling passage, and a second rib set including a plurality of ribs provided on an inner wall surface of the second wall facing the cooling passage, the second rib set being stacked on the first rib set so as to form a lattice pattern,

in which at least one of the first airfoil wall and the second airfoil wall is formed with a film cooling hole that penetrates from the inner wall surface of the airfoil wall to an outer wall surface of the airfoil wall in a lattice passage formed between the adjacent ribs.

According to this configuration, by using vortex flow of the cooling medium that has occurred in the lattice structure body, also for film cooling of the turbine airfoil outer wall surface, the entirety of the turbine airfoil can be efficiently cooled.

In one embodiment of the present invention, the cooling structure may further include partition bodies provided at opposite side portions of the lattice structure body, respectively, and substantially closing passages of the respective rib sets,

in which the lattice structure body includes a plurality of lattice communication portions that allow lattice passages formed between the plurality of ribs of the first rib set to communicate with lattice passages formed between the plurality of ribs of the second rib set, and

the film cooling hole is formed such that at least one lattice communication portion is present between a position in a lattice passage at which the film cooling is disposed and a lattice communication portion that is on a downstream side of the partition body and the partition body faces. According to this configuration, the cooling medium in which vortex flow having sufficient intensity has occurred by deflection at the partition body and traversing the ribs flows into the film cooling hole, and thus film cooling of the outer wall surface can be efficiently performed.

In one embodiment of the present invention, a plurality of the film cooling holes may be formed on the same lattice passage, and at least one lattice communication portion may be present between the plurality of the film cooling holes. According to this configuration, even in the case where a plurality of film cooling holes are provided on the same lattice passages, the cooling medium in which vortex flow having sufficient intensity has occurred by traversing the ribs is allowed to flow in through each film cooling hole.

In one embodiment of the present invention, the film cooling hole may be formed on an inner wall surface on a downstream side in a lattice communication portion that the partition body faces. According to this configuration, since the film cooling hole is formed at the side portion of the lattice structure body, the cooling medium is guided to the side portion of the lattice structure body. Thus, the cooling medium can be evenly supplied over the entirety of the lattice structure body.

In one embodiment of the present invention, the film cooling hole may extend so as to be inclined relative to the inner wall surface and the outer wall surface,

an angle α defined between an extension direction of the film cooling hole in a plan view and a flow direction of the high-temperature gas may fall within a range of 0°≤α≤90°, and

an angle β defined between the extension direction of the film cooling hole in a plan view and a flow direction in a lattice passage in which the film cooling hole is formed may fall within a range of −90°≤β≤90°. According to this configuration, the cooling medium is allowed to smoothly flow from the lattice passage into the film cooling hole on the inner wall surface, and vortex flow of the cooling medium is effectively allowed to flow along the outer wall surface.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a perspective view showing an example of a turbine airfoil to which a cooling structure according to a first embodiment of the present invention is applied;

FIG. 2 is a longitudinal cross-sectional view schematically showing the turbine airfoil in FIG. 1;

FIG. 3 is a transverse cross-sectional view of the turbine airfoil in FIG. 1;

FIG. 4 is a perspective view schematically showing a lattice structure body used in the cooling structure in FIG. 2;

FIG. 5 is a plan view schematically showing the lattice structure body used in the cooling structure in FIG. 2;

FIG. 6 is a plan view schematically showing an example of the form of supplemental ribs in the lattice structure body used in the cooling structure in FIG. 2;

FIG. 7 is a plan view schematically showing another example of the form of the supplemental ribs in the lattice structure body used in the cooling structure in FIG. 2;

FIG. 8 is a longitudinal cross-sectional view schematically showing an example of arrangement of the cooling structure according to the embodiment of the present invention;

FIG. 9 is a transverse cross-sectional view showing an example of a turbine airfoil to which a cooling structure according to a second embodiment of the present invention is applied;

FIG. 10 is a plan view schematically showing a lattice structure body used in the cooling structure in FIG. 9; and

FIG. 11 is a plan view schematically showing a lattice structure body used in a cooling structure according to a third embodiment of the present invention.

### DESCRIPTION OF EMBODIMENTS

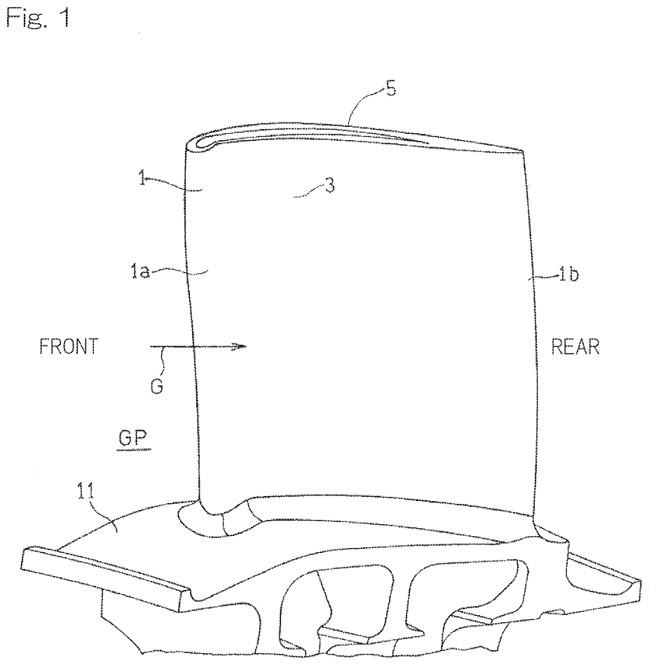

Hereinafter, embodiments of the present invention will be described with reference to the drawings. FIG. 1 is a perspective view showing a rotor blade 1 of a turbine of a gas turbine engine to which a cooling structure for a turbine airfoil according to a first embodiment of the present invention is applied. The turbine rotor blade 1 forms a part of a turbine that is driven by high-temperature gas G, flowing in an arrow direction, which is supplied from a combustor that is not shown. The turbine rotor blade 1 has: a first airfoil wall 3 that is curved so as to be concave relative to a passage GP for the high-temperature gas G; and a second airfoil wall 5 that is curved so as to be convex relative to the passage GP for the high-temperature gas.

In the present specification, although, for convenience sake, the airfoil wall that is curved so as to be concave relative to the passage GP for the high-temperature gas G is referred to as the first airfoil wall 3, and the airfoil wall that is curved so as to be convex relative to the passage GP for the high-temperature gas is referred to as the second airfoil wall 5, as described above, the structure of the first airfoil wall 3 and the structure of the second airfoil wall 5 may be interchanged with each other, unless particularly described otherwise. In addition, in the present specification, the upstream side along the flow direction of the high-temperature gas G (the left side in FIG. 1) is referred to as a front side, and the downstream side (the right side in FIG. 1) is referred to as a rear side. In the following description, the turbine rotor blade 1 is mainly described as an example of a turbine airfoil to which the cooling structure is provided, but the cooling structure according to the present embodiment may be similarly applied to a turbine stator vane that is a turbine airfoil, unless particularly described otherwise.

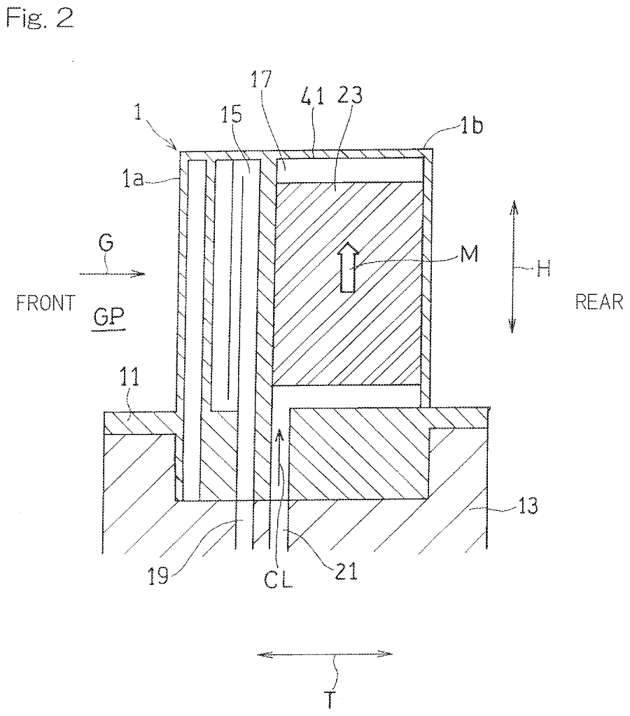

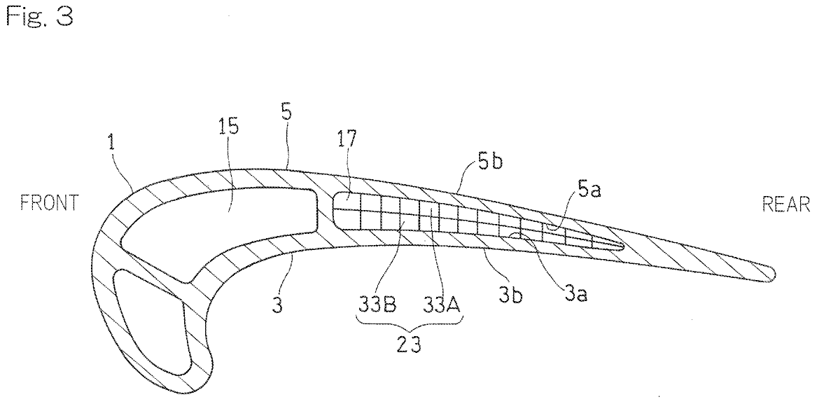

Specifically, a large number of turbine rotor blades 1 are provided in a circumferential direction in an embedded manner such that, as shown in FIG. 2, a platform 11 of each turbine rotor blade 1 is connected to an outer circumferential portion of a turbine disc 13, whereby the turbine is formed. A front cooling passage 15 is formed within a front portion 1a of the turbine rotor blade 1 so as to extend in a blade height direction H and turn back. A rear cooling passage 17 is formed within a rear portion 1b of the turbine rotor blade 1. These cooling passages 15 and 17 are formed by using a space between the first airfoil wall 3 and the second airfoil wall 5 as shown in FIG. 3.

As shown in FIG. 2, a cooling medium CL flows through a front cooling medium CL introduction passage 19 and a rear cooling medium CL introduction passage 21, which are formed within the turbine disc 13 at the radially inner side, toward the radially outer side, and is introduced into the front cooling passage 15 and the rear cooling passage 17, respectively. In the present embodiment, a part of a compressed air from a compressor that is not shown is used as the cooling medium CL. The cooling medium CL supplied to the front cooling passage 15 is discharged to the outside through a discharge hole that communicates with the outside of the turbine rotor blade 1 and that is not shown. The cooling medium CL supplied to the rear cooling passage 17 is discharged to the outside through a discharge hole that is provided in an airfoil wall at a tip portion of the turbine rotor blade 1 and that is not shown.

Hereinafter, an example in which the cooling structure according to the present embodiment is provided to the rear portion 1b of the turbine rotor blade 1 will be described. However, the cooling structure according to the present embodiment may be provided to any portion of the turbine rotor blade 1. In the present embodiment, in the rear cooling passage 17, the entirety of the cooling medium CL flows in a direction from a base portion side toward the tip portion side in the height direction H of the turbine rotor blade 1. In the present specification, the movement direction of the entirety of the cooling medium CL is referred to as a cooling medium movement direction M. In addition, a direction orthogonal to the cooling medium movement direction M in the rear cooling passage 17 is referred to as a transverse direction T.

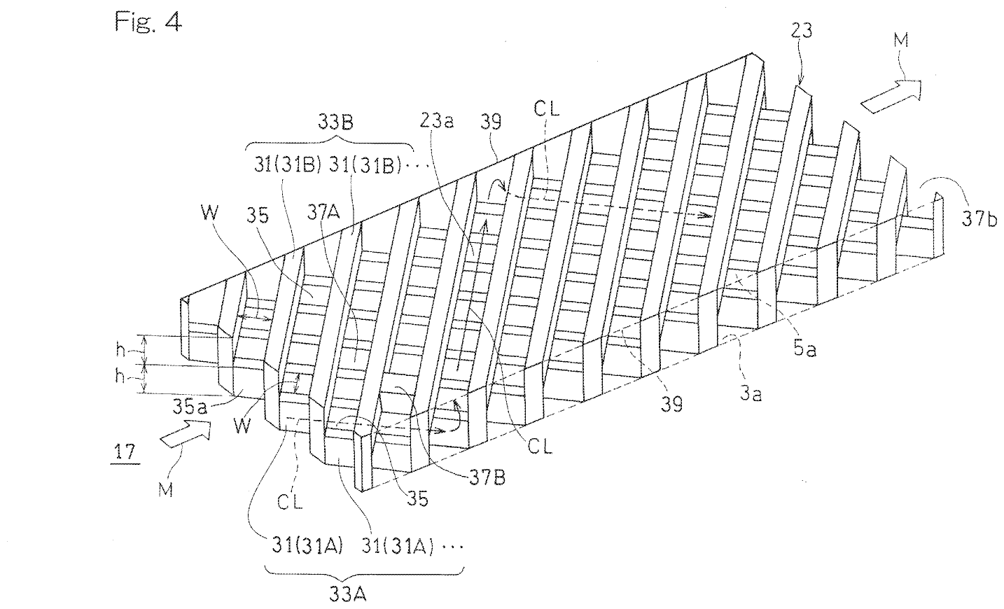

A lattice structure body 23 is provided within the rear cooling passage 17, as one element that forms a part of the cooling structure for internally cooling the turbine rotor blade 1. As shown in FIG. 4, the lattice structure body 23 is formed by stacking two rib sets each including a plurality of main ribs 31 on each other so as to form a lattice pattern on opposing wall surfaces of the rear cooling passage 17. In the present embodiment, a first rib set (lower rib set in FIG. 4) 33A including a plurality of first main ribs 31A that are arranged at equal intervals so as to be parallel to each other and a second rib set (upper rib set in FIG. 4) 33B including a plurality of second main ribs 31B that are arranged at equal intervals so as to be parallel to each other are stacked so as to form a lattice pattern. In other words, the first rib set 33A and the second rib set 33B are in contact with each other at intersection portions of the lattice pattern in a plan view. The first main ribs 31A and the second main ribs 31B are provided on two wall surfaces opposing each other in the blade thickness direction of the turbine rotor blade 1, that is, a first inner wall surface 3a that is an inner wall surface of the first airfoil wall 3 and a second inner wall surface 5a that is a wall surface of the second airfoil wall 5, respectively.

In the lattice structure body 23, the gap between the adjacent main ribs 31, 31 of each rib set 33A, 33B form a passage (lattice passage) 35 for the cooling medium CL. In the lattice structure body 23, the most upstream ends of the respective lattice passages 35 are not closed but are open at the upstream side, and these openings thereof form inlets (hereinafter, simply referred to as “lattice inlets”) 35a of the lattice passages 35. In the lattice structure body 23, the most downstream ends of the respective lattice passages 35 are not closed but are open on the downstream side, and these openings thereof form outlets (hereinafter, simply referred to as “lattice outlets”) 35b of the lattice passages 35.

In the lattice structure body 23 of the present embodiment, each of the rib sets 33A and 33B further includes supplemental ribs 37. Specifically, the first rib set 33A includes first supplemental ribs 37A that are provided on the first inner wall surface 3a and that are integrally provided to the first main ribs 31A so as to protrude in the lattice passages 35 each formed between the adjacent first main ribs 31A. Similarly, the second rib set 33B includes second supplemental ribs 37B that are provided on the second inner wall surface 5a and that are integrally provided to the second main ribs 31B so as to protrude in the lattice passages 35 each formed between the adjacent second main ribs 31B. FIG. 4 shows only one of a plurality of the first supplemental ribs 37A provided in the rib set 33A and only one of a plurality of the second supplemental ribs 37B provided in the rib set 33B.

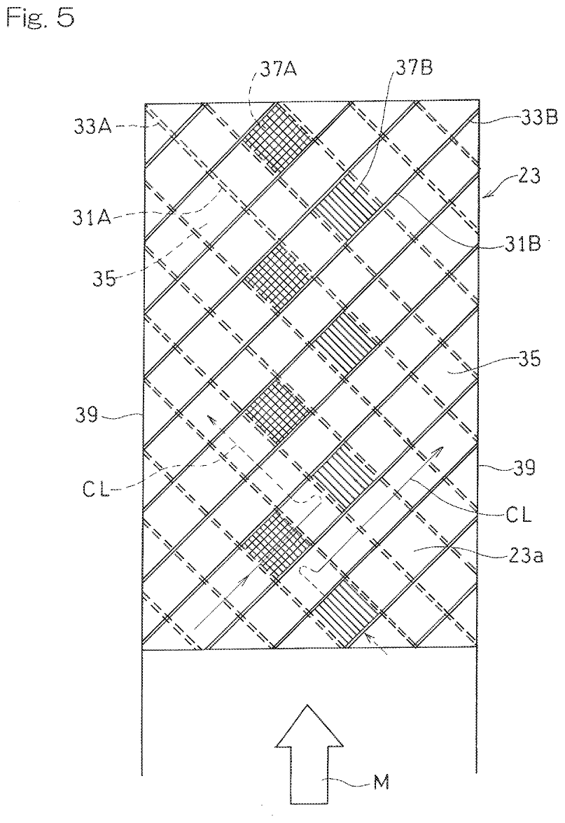

As shown in FIG. 5, the first supplemental ribs 37A shown by double hatching and the second supplemental ribs 37B shown by single hatching are provided at positions that do not overlap each other in the direction in which the first inner wall surface 3a and the second inner wall surface 5a oppose each other (in a plan view). In FIG. 5, the first rib set 33A is shown at the back side of the sheet by broken lines, and the second rib set 33B is shown at the front side of the sheet by solid lines. In the lattice structure body 23, lattice communication portions 23a each of which is a portion that allows the lattice passage 35 of the first rib set 33A and the lattice passage 35 of the second rib set 33B to communicate with each other (that is, a portion where the lattice passage 35 of the first rib set 33A and the lattice passage 35 of the second rib set 33B intersect each other in a plan view) are formed. In the present embodiment, the first supplemental ribs 37A and the second supplemental ribs 37B are arranged in respective lattice communication portions 23a different from each other.

In the present embodiment, in each rib set 33A, 33B, the supplemental rib 37 is disposed in each of a plurality of the lattice communication portions 23a that are continuously arranged along the cooling medium movement direction M (FIG. 5 shows only the supplemental ribs 37 that are provided in alternate lattice communication portions 23a). As a matter of course, the positions at which the supplemental ribs 37 are provided are not limited to this example, as long as the positions at which the first supplemental ribs 37A and the second supplemental ribs 37B do not overlap each other in the direction in which the first inner wall surface 3a and the second inner wall surface 5a oppose each other. The supplemental ribs 37 may be selectively arranged such that the cooling efficiency by the lattice structure body 23 is optimized in accordance with a thermal load distribution within the turbine airfoil that depends on the shape of the turbine airfoil, the installation environment, the shapes of the cooling passages, etc.

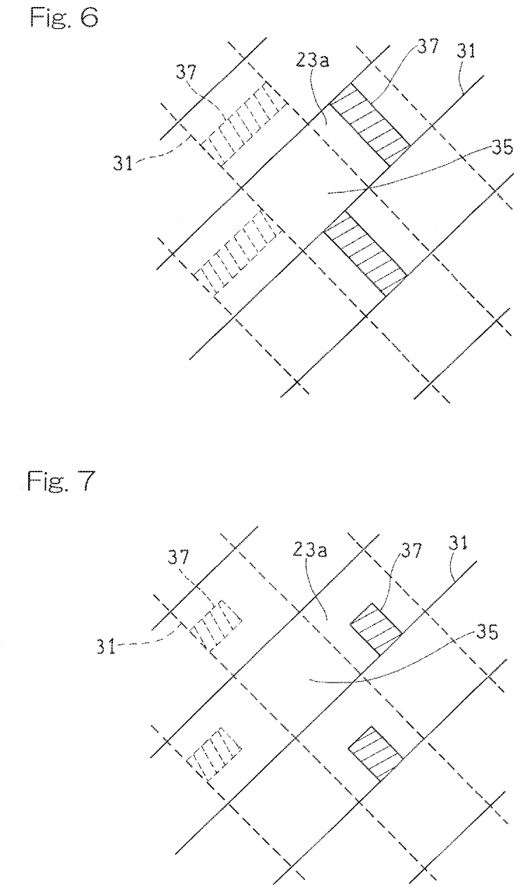

In the shown example, each supplemental rib 37 is protrudingly provided so as to substantially close the lattice communication portion 23a. As a matter of course, the form of the supplemental rib 37 is not limited to this example as long as the supplemental rib 37 is provided so as to protrude in the lattice passage 35 from the main rib 31. For example, as shown in FIG. 6, the supplemental rib 37 may be protrudingly provided such that a gap is formed in the lattice communication portion 23a while the lattice passage 35 is closed. Alternatively, as shown in FIG. 7, the supplemental rib 37 may be protrudingly provided such that the lattice passage 35 is not fully closed, that is, such that a gap is present between the adjacent main ribs 31.

The cooling medium CL introduced into the lattice structure body 23 initially flows into the lattice passage 35 through the lattice inlet 35a of one rib set (the lower first rib set 33A in the shown example) and traverses the other rib set (the upper second rib set 33B in the shown example) as shown by a broken line arrow in FIG. 4, thereby generating vortex flow. That is, in the lattice structure body 23, the cooling medium CL generates vortex flow by passing through the lattice communication portions 23a.

Thereafter, the cooling medium CL collides against a partition body 39, so as to be deflected, and flows from the collision portion into the lattice passage 35 of the other rib set (the upper second rib set 33B in the shown example) as shown by a solid line arrow in FIG. 4. The partition body 39 is a structure body provided at each lateral side of the lattice structure body 23. As each partition body 39, any member may be used as long as the member can substantially block flow of the cooling medium CL flowing through the lattice passages 35 and the cooling medium CL can be collided at the side portion of the lattice structure body 23 and deflected so as to flow from one lattice passage 35 into another lattice passage 35. In the present embodiment, a flat plate-like side wall is used as each partition body 39, but, for example, a plurality of partition pin fins may be used as each partition body 39.

Furthermore, in the present embodiment, as shown in FIG. 5, the cooling medium CL collides against the supplemental ribs 37 that protrude in the lattice passage 35 in the process of flowing through the lattice passage 35. Also due to the collision against each supplemental rib 37, the cooling medium CL is deflected and flows into another lattice passage 35. That is, also in a portion where a continuously provided structure body such as a partition body is not provided, deflection of the cooling medium CL into another lattice passage 35 occurs.

After repeating a process of flowing through the lattice passage 35 and flowing into other lattice passages 35 at the partition body 39 and the supplemental ribs 37 in the lattice structure body 23 as described above, the cooling medium CL is discharged from the lattice structure body 23.

In the present embodiment, as shown in FIG. 4, at the respective outlet 35b portions of the lattice passages 35, the heights (projection heights from the inner wall surfaces) of the respective upper and lower main ribs 31, that is, heights h of the lattice passages 35 in the blade thickness direction, are equal to each other. In addition, the interval between the main ribs 31, 31 in the first rib set 33A and the interval between the main ribs 31, 31 in the second rib set 33B are equal to each other. That is, a lattice passage width w in the first rib set 33A and a lattice passage width w in the second rib set 33B are equal to each other. The arrangement configuration of the plurality of main ribs 31 in each rib set is not limited to the shown example, and may be set as appropriate in accordance with the structure of the turbine airfoil, required cooling performance, etc.

In the shown example, the projection heights of the supplemental ribs 37 from the inner wall surfaces 3a and 5a are equal to the heights (that is, the heights of the lattice passages 35 in the blade thickness direction) h of the main ribs 31. Accordingly, the cooling medium CL can be effectively deflected by the supplemental ribs 37. Furthermore, the supplemental ribs 37 are easily formed so as to be integrated with the main ribs 31. The projection heights of the supplemental ribs 37 from the inner wall surfaces 3a and 5a may be optionally set, but are each preferably not less than ½ of the height h of each main rib, in order to assuredly deflect the cooling medium CL.

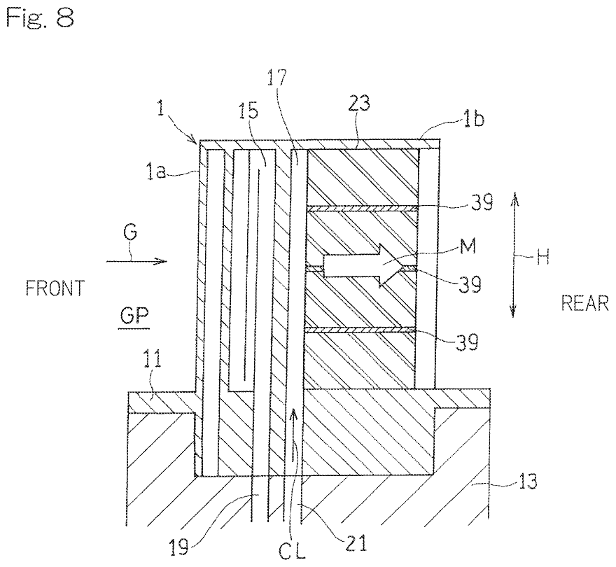

In the present embodiment, the cooling medium movement direction M in the rear cooling passage 17 is the direction from the base portion side toward the tip portion side in the height direction of the turbine rotor blade 1. However, as shown in FIG. 8, the cooling medium movement direction M may be a blade chord direction, that is, a direction along the flow direction of the high-temperature gas G outside the turbine rotor blade 1. In this case, as shown in FIG. 8, a plurality of lattice structure bodys 23 may be disposed so as to be aligned in the height direction H with partition bodies 39 interposed therebetween. In the shown example, four lattice structure bodys 23 are aligned in the height direction H with three partition bodies 39 interposed therebetween.

In the cooling structure according to the first embodiment described above, by the cooling medium CL passing through the lattice communication portions 23a and traversing the other rib set extending in a direction traversing the lattice passage 35, vortex flow is generated in flow of the cooling medium CL, and cooling of the wall surfaces 3a and 5a is enhanced. In addition, by the cooling medium CL colliding against the supplemental rib 37 that protrudes in the lattice passage 35, the cooling medium CL is deflected to another lattice passage 35, so that the same cooling effect as that in the case where a partition plate that is a continuously provided structure is provided (promotion of heat transfer by contact with a wall surface that spreads in a direction that intersects the flow direction) can be obtained without providing such a partition plate. Furthermore, unlike a continuous partition plate, it is easy to selectively arrange the supplemental ribs 37 such that the cooling efficiency by the lattice structure body 23 is optimized in accordance with the thermal load distribution within the turbine airfoil. Therefore, high cooling efficiency can be achieved while durability reduction of the turbine airfoil is suppressed.

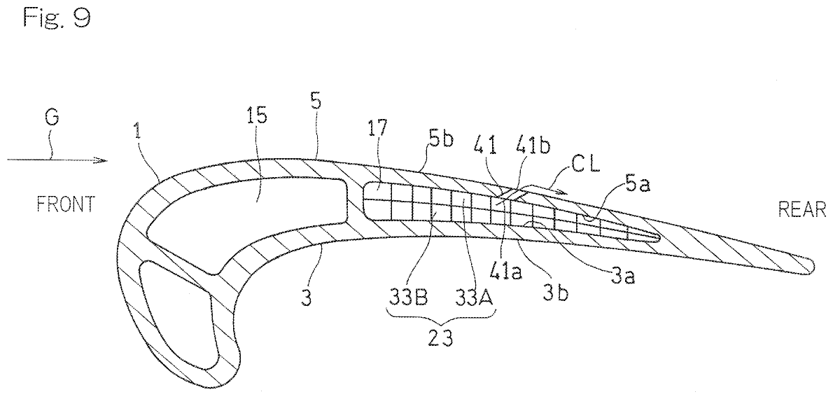

FIG. 9 shows a cooling structure for a turbine airfoil according to a second embodiment of the present invention. In the present embodiment, in the cooling structure according to the first embodiment described with reference to FIG. 1 to FIG. 8, at least one of the first airfoil wall 3 and the second airfoil wall 5 is formed with a film cooling hole 41 that penetrates from the inner wall surface on which the lattice structure body 23 is provided (the second inner wall surface 5a in the shown example) to an outer wall surface 5b of the airfoil wall 5. The cooling medium CL is led out from the interior of the turbine rotor blade 1 through the film cooling holes 41 onto the outer wall surface and flows along the outer wall surface 5b, whereby film cooling that blocks heat transfer from the high-temperature gas G to the turbine rotor blade 1 is performed. Hereinafter, the differences from the first embodiment will be mainly described, and the description of components the same as those in the first embodiment is omitted.

Each film cooling hole 41 extends so as to be inclined relative to the inner wall surface 5a and the outer wall surface 5b (that is, relative to the thickness direction of the airfoil wall 5) in order to assuredly allow the cooling medium CL to flow along the outer wall surface 5b. In other words, the position of a film cooling hole inlet 41a, which is an opening of the film cooling hole 41 in the inner wall surface 5a, and the position of a film cooling hole outlet 41b, which is an opening of the film cooling hole 41 in the outer wall surface 5b are displaced from each other in a plan view thereof.

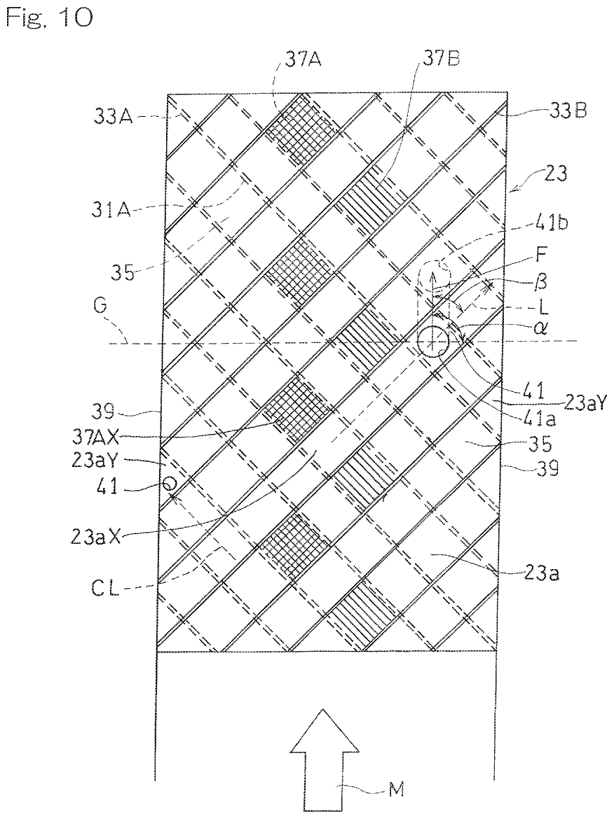

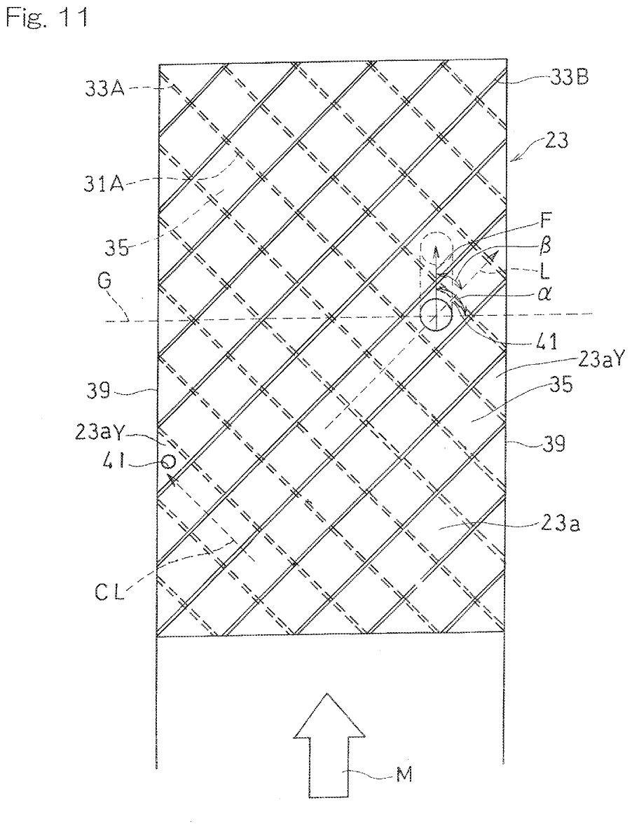

In the present embodiment, for convenience sake, an example in which the film cooling holes 41 are formed in the second airfoil wall 5 will be described. In this example, as shown in FIG. 10, each film cooling hole 41 penetrates from a portion of the second inner wall surface 5a on the downstream side with respect to a position corresponding to the first supplemental rib 37A in the lattice passage 35 formed between the second main ribs 31B, to the outer wall surface 5b of the second airfoil wall 5. That is, the film cooling hole 41 has a film cooling hole inlet 41a in the lattice communication portion 23a on the downstream side with respect to the lattice communication portion 23a located at the position corresponding to the first supplemental rib 37A in the lattice passage 35 formed between the second main ribs 31B. In the present specification, the “position corresponding to the supplemental rib” refers to a position at which the cooling medium CL is deflected due to the supplemental rib 37. Specifically, as shown in FIG. 10, in the case where each supplemental rib 37 is provided so as to close the lattice communication portion 23a, the cooling medium CL that has collided against the supplemental rib 37 (the first supplemental rib shown by reference numeral “37AX” in FIG. 10) is deflected at the lattice communication portion 23a (the lattice communication portion shown by reference number “23aX” in FIG. 10) adjacent to (upstream side of) the lattice communication portion 23a in which the supplemental rib 37 is disposed. Thus, the position of the lattice communication portion 23aX is the “position corresponding to the supplemental rib”. Meanwhile, in the case where each supplemental rib 37 is provided so as not to close the lattice communication portion 23a as shown in FIG. 6 or 7, the position of the lattice communication portion 23a in which the supplemental rib 37 is provided is the “position corresponding to the supplemental rib”.

The film cooling holes 41 may be formed only in the first airfoil wall 3, or may be formed in both the first airfoil wall 3 and the second airfoil wall 5. In the case where the film cooling holes 41 are formed in the first airfoil wall 3, each film cooling hole 41 penetrates to an outer wall surface 3b of the first airfoil wall 3 from a portion, of the first inner wall surface 3a, that is on the downstream side with respect to the position, in the lattice passage 35 formed between the first main ribs 31A, 31A, corresponding to the second supplemental rib 37B, such that at least one lattice communication portion 23a is present between the portion of the first inner wall surface 3a and the lattice communication portion 23a in which the second supplemental rib 37B is located.

By such formation, the cooling medium CL having stronger vortex flow by traversing the main ribs 31 after colliding against the supplemental rib 37 and deflection can be effectively used for film cooling of the outer wall surface 5b.

Moreover, the film cooling hole 41 is formed at a position on the downstream side with respect to the partition body 39 in the lattice passage 35 in which the film cooling hole 41 is formed, such that at least one lattice communication portion 23a is present between the position in the lattice passage 35 in which the film cooling hole 41 is formed and the lattice communication portion 23a that the partition body 39 faces. The “lattice communication portion 23a that the partition body 39 faces” refers to a lattice communication portion 23a (a lattice communication portion shown by reference numeral “23aY” in FIG. 10) that is formed at a side portion of the lattice structure body 23 and that is defined by both rib sets 33A and 33B and the partition body 39. With such a configuration, the cooling medium CL in which vortex flow having sufficient intensity has occurred by traversing the main ribs 31 flows into the film cooling hole 41, and thus film cooling of the outer wall surface 5b can be efficiently performed.

For similar reason, in the case where a plurality of film cooling holes 41 are formed on the same lattice passage 35, it is preferable that at least one lattice communication portion 23a is present between those film cooling holes 41, 41.

Furthermore, the film cooling hole 41 may be formed in the inner wall surface on the downstream side in the lattice communication portion 23aY that the partition body 39 faces. In the example shown in FIG. 10, in the lattice communication portion 23aY that the partition body 39 at the left side faces, the film cooling hole 41 is formed in the second inner wall surface 5a at the front side of the sheet. By the film cooling hole 41 formed at this position, that is, at the side portion of the lattice structure body 23, the cooling medium CL is guided to the side portion of the lattice structure body 23. Thus, the cooling medium CL is prevented from excessively flowing out to another lattice passage 35 via the lattice communication portion 23a located inward of the side portion. That is, it is possible to adjust an amount of the cooling medium CL flowing out via the lattice communication portion 23a, by forming the film cooling hole 41 at the side portion of the lattice structure body 23 and setting the arrangement or the size thereof as appropriate. Thus, the cooling medium CL can be evenly supplied over the entirety of the lattice structure body 23.

The sizes and the shapes of the film cooling holes 41 formed in the region where the lattice structure body 23 is provided may be set as appropriate in accordance with the positions or the number thereof, etc. For example, the opening diameter of the film cooling hole 41 located in the lattice communication portion 23a that the partition body 39 faces may be smaller than the opening diameter of the film cooling hole 41 located inward thereof.

In the present embodiment, an angle a between an extension direction F of the film cooling hole 41 in a plan view and the flow direction of the high-temperature gas G falls within the range of 0°≤α≤90°, and an angle β between the extension direction F of the film cooling hole 41 in a plan view and a flow direction L in the lattice passage 35 in which the film cooling hole 41 is formed falls within the range of −90°≤β≤90°. By setting the value of the angle α to be within the above range, vortex flow of the cooling medium CL is effectively allowed to flow along the outer wall surface 5a. By setting the value of the angle β to be within the above range, the cooling medium CL is allowed to smoothly flow from the lattice passage 35 into the film cooling hole 41 on the inner wall surface 5b.

As described above, by the film cooling holes 41 which penetrate from the inner wall surface 5a, on which the lattice structure body 23 having the supplemental ribs 37 is provided, to the outer wall surface 5b, it is possible to use vortex flow of the cooling medium CL that has occurred in the lattice structure body 23 having the supplemental ribs 37, also for film cooling of the outer wall surface 5b of the turbine airfoil, and thus the entirety of the turbine airfoil can be efficiently cooled.

As illustrated as a third embodiment shown in FIG. 11, also in the case where the lattice structure body 23 only has main ribs 31 and does not have any supplemental rib 37, a film cooling hole 41 that penetrates from the inner wall surface 5a, on which the lattice structure body 23 is provided, to the outer wall surface 5b of the airfoil wall 5 may be formed in at least one of the first airfoil wall 3 and the second airfoil wall 5 (the second airfoil wall 5 in the shown example). In the cooling structure according to this embodiment, the entirety of the turbine airfoil can be efficiently cooled by using vortex flow of the cooling medium CL that has occurred in the lattice structure body 23, also for film cooling of the turbine airfoil outer wall surface 5b.

Moreover, in this embodiment as well, a film cooling hole 41 may be formed at a position on the downstream side of the partition body 39 in the lattice passage 35 in which the film cooling hole 41 is formed such that at least one lattice communication portion 23a is present between the position in the lattice passage 35 in which the film cooling hole 41 is formed and the lattice communication portion 23aY that the partition body 39 faces. Similarly, in the case where a plurality of film cooling holes 41 are formed on the same lattice passage 35, at least one lattice communication portion 23a may be present between the film cooling holes 41, 41.

Moreover, in this embodiment as well, the film cooling hole 41 may be formed in the inner wall surface on the downstream side in the lattice communication portion 23aY that the partition body 39 faces.

Moreover, in this embodiment as well, each film cooling hole 41 may be extended so as to be inclined relative to the inner wall surface 5a and the outer wall surface 5b, the angle α between the extension direction F of the film cooling hole 41 in a plan view and the flow direction of the high-temperature gas G may fall within the range of 0°≤α≤90°, and the angle β between the extension direction F of the film cooling hole 41 in a plan view and the flow direction L in the lattice passage 35 in which the film cooling hole 41 is formed may fall within the range of −90°≤β≤90°.

Although the present invention has been described above in connection with the embodiments thereof with reference to the accompanying drawings, numerous additions, changes, or deletions can be made without departing from the gist of the present invention. Accordingly, such additions, changes, or deletions are to be construed as included in the scope of the present invention.

### REFERENCE NUMERALS

1 . . . Turbine rotor blade (Turbine airfoil)

3 . . . First airfoil wall

3a . . . Inner wall surface of first airfoil wall

3b . . . Outer wall surface of first airfoil wall

5 . . . Second airfoil wall

5a . . . Inner wall surface of second airfoil wall

5b . . . Outer wall surface of second airfoil wall

17 . . . Rear cooling passage (cooling passage)

23 . . . Lattice structure body

23a . . . Lattice communication portion

31 . . . Main rib

33 . . . Rib set

35 . . . Lattice passage

37 . . . Supplemental rib

41 . . . Film cooling hole

CL . . . Cooling medium

G . . . High-temperature gas

GP . . . Passage for high-temperature gas

What is claimed is:

1. A cooling structure for cooling a turbine airfoil of a turbine driven by high-temperature gas, the cooling structure comprising:
a cooling passage formed between a first airfoil wall and a second airfoil wall of the turbine airfoil that oppose each other; and
a lattice structure body including
a first rib set including a plurality of first main ribs, provided on a first inner wall surface of the first airfoil wall facing the cooling passage, that extend linearly and arranged so as to be parallel to each other, and
a second rib set including a plurality of second main ribs, provided on a second inner wall surface of the second airfoil wall facing the cooling passage, that extend linearly and are arranged so as to be parallel to each other, the second rib set being stacked on the first rib set so as to form a lattice pattern,
wherein the first rib set includes a first supplemental rib that is provided on the first inner wall surface and integrally provided to the first main rib so as to protrude in a lattice passage formed between the adjacent first main ribs, and
the second rib set includes a second supplemental rib that is provided on the second inner wall surface and integrally provided to the second main rib so as to protrude in a lattice passage formed between the adjacent second main ribs, the second supplemental rib being disposed at a position that do not overlap the first supplemental rib in a direction in which the first inner wall surface and the second inner wall surface oppose each other.

2. The cooling structure as claimed in claim 1, wherein
a movement direction of an entirety of a cooling medium is a direction from a base portion toward a tip portion in a height direction of the turbine airfoil, and
a greater number of the first supplemental rib and a greater number of the second supplemental rib are arranged in a region on the base portion side of the turbine airfoil in the lattice structure body.

3. The cooling structure as claimed in claim 2, wherein the first supplemental ribs and the second supplemental ribs are arranged only in a half region on the base portion side of the turbine airfoil in the lattice structure body.

4. The cooling structure as claimed in claim 1, wherein at least one of the first airfoil wall and the second airfoil wall is formed with a film cooling hole that penetrates from the inner wall surface of the airfoil wall on which the lattice structure body is provided, to an outer wall surface of the airfoil wall.

5. The cooling structure as claimed in claim 4, wherein
the lattice structure body includes a plurality of lattice communication portions that allow lattice passages formed between the plurality of the first main ribs to communicate with lattice passages formed between the plurality of the second main ribs, and
the film cooling hole is formed in the second airfoil wall and penetrates to an outer wall surface of the second airfoil wall from a portion of the second inner wall surface, that is on a downstream side with respect to a position, in the lattice passage between the second main ribs, corresponding to the first supplemental rib, such that at least one lattice communication portion is present between the portion of the second inner wall surface and a lattice communication portion at the position corresponding to the first supplemental rib.

6. A cooling structure for cooling a turbine airfoil of a turbine driven by high-temperature gas, the cooling structure comprising:
a cooling passage formed between a first airfoil wall and a second airfoil wall of the turbine airfoil that oppose each other; and
a lattice structure body including a first rib set including a plurality of ribs provided on an inner wall surface of the first airfoil wall facing the cooling passage, and a second rib set including a plurality of ribs provided on an inner wall surface of the second wall facing the cooling passage, the second rib set being stacked on the first rib set so as to form a lattice pattern,
wherein at least one of the first airfoil wall and the second airfoil wall is formed with a film cooling hole that penetrates from the inner wall surface of the airfoil wall to an outer wall surface of the airfoil wall in a lattice passage formed between the adjacent ribs.

7. The cooling structure as claimed in claim 6, further comprising partition bodies provided at opposite side portions of the lattice structure body, respectively, and substantially closing passages of the respective rib sets,
wherein the lattice structure body includes a plurality of lattice communication portions that allow lattice passages formed between the plurality of ribs of the first rib set to communicate with lattice passages formed between the plurality of ribs of the second rib set, and
the film cooling hole is formed such that at least one lattice communication portion is present between a position in a lattice passage at which the film cooling is disposed and a lattice communication portion that is on a downstream side of the partition body and the partition body faces.

8. The cooling structure as claimed in claim 6, wherein the lattice structure body includes a plurality of lattice communication portions that allow lattice passages formed between the plurality of ribs of the first rib set to communicate with lattice passages formed between the plurality of ribs of the second rib set, a plurality of the film cooling holes are formed on the same lattice passage, and at least one lattice communication portion is present between the plurality of the film cooling holes.

9. The cooling structure as claimed in claim 6, further comprising partition bodies provided at opposite side portions of the lattice structure body, respectively, and substantially closing passages of the respective rib sets,
wherein the lattice structure body includes a plurality of lattice communication portions that allow lattice passages formed between the plurality of ribs of the first rib set to communicate with lattice passages formed between the plurality of ribs of the second rib set, and
the film cooling hole is formed on an inner wall surface on a downstream side in a lattice communication portion that the partition body faces.

10. The cooling structure as claimed in claim 6, wherein
the film cooling hole extends so as to be inclined relative to the inner wall surface and the outer wall surface,
an angle α defined between an extension direction of the film cooling hole in a plan view and a flow direction of the high-temperature gas falls within a range of 0°≤α≤90°, and
an angle β defined between the extension direction of the film cooling hole in a plan view and a flow direction in a lattice passage in which the film cooling hole is formed falls within a range of −90°≤β≤90°.
